(19) United States
(12) Patent Application Publication
(10) Pub. No.: US 2007/0183133 A1
(43) Pub. Date: Aug. 9, 2007

(54) Mains wire antenna for wireless interface applications

(75) Inventors: Arnold Willem Buij, Eindhoven (NL); Marcel Beij, Eindhoven (NL); Johannes Hendrik Wessels, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/599,844

(22) PCT Filed: Apr. 12, 2005
(86) PCT No.: PCT/IB05/51199

§ 371 Date: Oct. 11, 2006

(30) Foreign Application Priority Data
Apr. 15, 2004 (EP) 04101557.9

(51) Int. Cl. F21V 33/00

(52) U.S. Cl. 362/85

(57) ABSTRACT

The present invention deals with wireless control of a lamp such as a fluorescent lamp controlled by a ballast with a wireless control interface for RF communication. The receiver input and the transmitter output of the control interface module are connected to one or more mains wires by means of (a) coupling capacitor(s) or a Lecher line transformer. During operation the one or more mains wires serve as the lamp antenna.

### FIELD OF THE INVENTION

The invention relates to wireless control of a lamp and in particular relates to the architecture of the antenna of the lamp's control interface.

### BACKGROUND OF THE INVENTION

Lighting control in an office or commercial building has gone through several stages ranging from “on/off”-control of a single lamp or a group of lamps, through dimming of a single lamp or a group of lamps, to advanced control of the lighting in an entire building. In normal lighting systems it is the individual lamp drivers of the luminaires that are controlled. The traditional lamp driver systems are wired control interface systems, such as the standard 1-10 V dimming interface and more recently digital systems, such as the Digital Addressable Lighting Interface (DALI). The interface systems are moving towards wireless interfaces, such as systems implementing the ZigBee standard, a system that uses radio frequencies around 2.4 GHz.

A wireless interface using electromagnetic signals needs an antenna for transmission and reception of control signals. For a lamp driver the situation is, however, complicated by the fact that the application has a metal housing. The housing will isolate an internal antenna from the environment, thereby largely blocking the transmission and reception of the electromagnetic signals. Furthermore the lamp driver itself can be enclosed in a metal housing that further attenuates the electromagnetic signals. In some technological areas this is not a problem. For example, a cellular phone has a plastic housing and the antenna can be located completely inside the application.

In the U.S. patent application 2003/0090889 a ballast with an integrated RF wireless interface is disclosed. For a ballast with an embedded antenna, it is disclosed that in order to get the radiation outside the ballast, a plastic case may be used as a cover for the ballast, or in case of a metal cased ballast, a halfwavelength slot antenna may be used as the cover.

### SUMMARY OF THE INVENTION

The present invention seeks to provide an improved wireless control interface for a lamp driver. Preferably, the invention alleviates or mitigates one or more of the above disadvantages singly or in any combination.

Accordingly in a first aspect, there is provided a device for wireless control of a lamp, the device comprising:
a control interface, and
a body for emitting light
   wherein the control interface is connected to a mains network comprising at least two mains wires, and wherein at least one of the mains wires is used as a first antenna for wireless control of the lamp.

In a wirelessly controlled lamp, the control interface is capable of receiving and transmitting control signals through connection to an antenna. In the present invention by using as the antenna, at least one of the mains wires to which the lamp is connected, a separate antenna may be avoided and thereby facilitating a simplified design of the control system of the lamp. This may lead to reducing cost of the system, smaller systems, etc. As an important consequence no restriction from the presence of an antenna is imposed on the design of the lamp driver housing, the material of the lamp driver housing, or on the surroundings of the lamp driver.

Irrespectively of the type of lamp and irrespectively whether the lamp driver is enclosed in a metal housing, the mains wires may be connected to a lamp in such a way that at least a section of at least one of the mains wires is in electromagnetic communication with the surroundings. Internal lamp wires, i.e. wires present inside the luminaire may perform poorly as an antenna since they may be enclosed inside metal shielding or other types of electromagnetic shielding. The mains wires will have to exit the luminaire at some place. Therefore the present invention may be implemented in any type of existing lamp system which is connected to a mains network. The implementation may be provided without use of extra connectors and/or without changes in the lamp driver housing and/or the luminaire. The lamp may be a fluorescent lamp, and more specifically it may be a fluorescent lamp of a TL type, a PL type or a HID type.

Mains wires may for safety, or other, reasons lie within metal tubing. In such a situation a small connector piece may be inserted between the mains network and the luminaire. The connector piece may be mains wires embedded in an electromagnetic transparent material, such as plastic. The connector piece may, e.g. also be a section of the mains wire which is not surrounded by the metal tube.

The wireless control interface of the present invention is a part of a lamp driver or is communicatively connected to the lamp driver circuitry. The term communicatively connected should be construed broadly. The term should be construed at least to include that the lamp driver and the control interface are an integral part of the same electronic circuitry, as well as the lamp driver and the wireless control interface are implemented in separate circuits that are electrically connected to each other by any suitable means for connecting two electrical circuits.

The control interface may be individually addressable and allow for bi-directional communication between the control interface and a user control device, such as a wall switch, or a control system, such as a computer control system adapted to control the lighting in a lighting system. A power source or feed source is normally connected to the luminaire, and the luminaire may include a stage communicatively connected to the control interface for handling the power supply in order to maintain light emission from the lamp. The lamp driver and/or control interface may include processing means, the processing means may be any type of processing means capable of controlling the lamp. For example the processing means may be an electronic circuit including one or more microprocessors or an integrated circuit. The processing means may be connected to a storage means for reading and storing digital data, such as to a flash memory or an EEPROM.

The control interface may be adapted to receive and transmit, i.e. to operate, using a specific frequency. However, the system may also be adapted to operate in a specific frequency range, or at a multitude of different frequencies. The control interface may be adapted to operate in the radio frequency range, for example the radio frequency range utilized in the ZigBee standard, a system that uses radio frequencies around 2.4 GHz. The control interface may also be adapted to operate in the infrared frequency range or any other frequency range suitable for a wirelessly controlled lamp system.

The control interface may be connected to at least one of the mains wires through a capacitive circuit. The receiver input and the transmitter output of the control interface may be connected to one or more mains wires through a capacitive circuit. The capacitive circuit may be a single capacitor, however the capacitive circuit may also be an electric circuit of two or more capacitors and possibly also other types of electrical components such as one or more resistors.

A fluorescent lamp will not activate until a certain threshold voltage difference or ignition voltage has been applied between the electrodes. The capacitive circuit may be adapted to be capable of withstanding the ignition voltages necessary to activate the fluorescent lamp. The capacitive circuit may be adapted to be capable of withstanding at least a few kilovolts, such as between 500 volts and 5 kilovolt, such as between 1 and 4 kilovolts, such as between 2 and 3 kilovolts. It may be a requirement that the capacitive circuit is able to withstand mains voltage and surges and have the same safety specifications as a standard mains filter capacitor.

The signal received by or imposed to at least one of the mains wires may as an alternative to a capacitive circuit be coupled to the control interface by means of a Lecher line transformer. In principle any inductive coupling circuit may be used for connecting at least one of the mains wires to the control interface.

The device may further include a user control comprising a second antenna so that signals can be transmitted to and/or received by the first antenna. The user control may be a wall switch, i.e. a switch or module attached to the wall from where one or more lamps can be controlled. The user control may also be a remote control, or a user control attached to other places than the traditional wall position.

According to a second aspect, wireless communication is established between a lamp driver and a control interface for controlling the lamp driver by use of at least one of the mains wires connected to a lamp as an antenna for wireless control of the lamp.

According to a third aspect, wireless communication is established between a lamp driver and a control interface by a method of transmitting and/or receiving signals between a lamp comprising a first antenna and a user unit comprising a second antenna, wherein at least a section of one of the mains wires connected to the lamp is the first antenna.

These and other aspects, features and/or advantages of the invention will be apparent from and elucidated with reference to the embodiments described hereinafter.

### BRIEF DESCRIPTION OF THE DRAWINGS

Preferred embodiments of the invention will now be described in details with reference to the drawings in which:

FIG. 1 illustrates a first embodiment of a device according to the present invention,

FIG. 2 illustrates a second embodiment of a device according to the present invention, and

FIG. 3 illustrates wireless communication between a wall unit and a fluorescent lamp.

In the drawings like reference numerals are used for like features in the different drawings.

### DESCRIPTION OF PREFERRED EMBODIMENTS

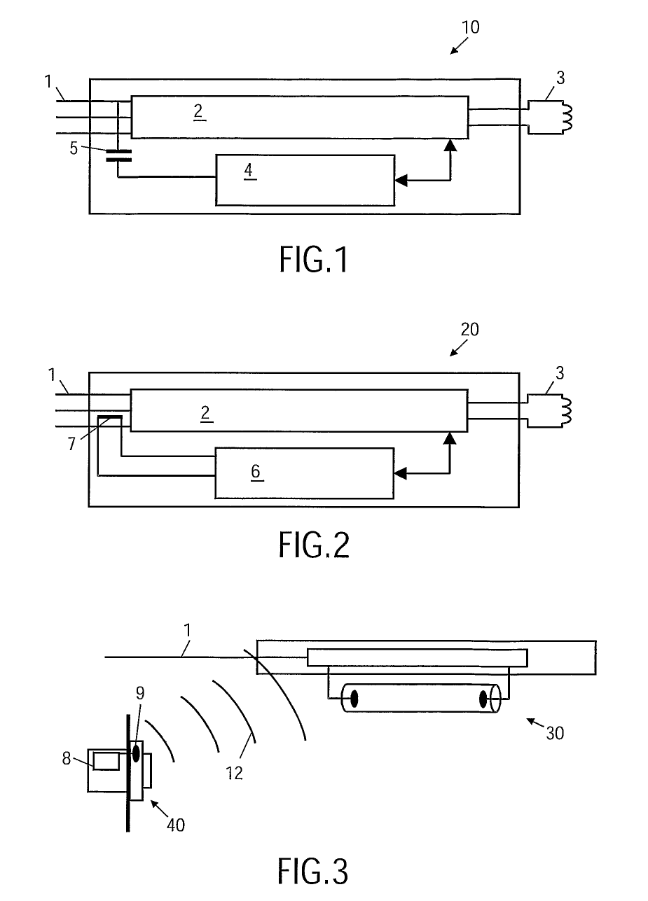

A first embodiment of a device 10 according to the present invention is illustrated in FIG. 1. The lamp is in the illustrated embodiment a fluorescent lamp. The figure illustrates the main components present in a lamp driver. The lamp driver is connected to mains 1 for example by direct cable connection to live (L), neutral (N) and possible protective earth (PE) of a mains network. The lamp driver comprises a driver circuit 2 connected to the electrodes 3 of the lamp (only one electrode shown here). The driver circuit is capable of controlling light emission, thus capable of at least starting the emission process of a fluorescent lamp and maintaining a substantially constant light emission level from the lamp. The lamp driver circuitry is communicatively connected to a control interface 4. The control interface 4 being able to extract or impose an alternating signal from or to the at least one of the mains wires 1 by use of a capacitive coupling 5.

The control interface 4 receives or transmits data to or from an external unit by of the at least one of the mains wires 1 as the antenna. In the receiving mode, the control interface may receive modulated data via the antenna, the data may then be demodulated and processed by an electric circuitry being part of the control interface. The data is further processed into control signals for controlling the lamp driver 2. In the transmitting mode, data may be modulated and transmitted via the antenna to an external unit. The coupling capacitor is in this embodiment connected to live connection of the mains. Using another coupling capacitor, the coupling capacitor may be connected to neutral, this can have the advantage of a somewhat higher antenna efficiency, but at the cost of an extra component.

In FIG. 2 a different embodiment 20 is illustrated. In this embodiment the control interface 6 is able to extract or impose an alternating signal from or to least one of the mains wires 1 by means of an inductive coupling 7. As an example of an inductive coupling a Lecher line transformer may be used. In the figure, the transformer establishes an RF coupling to the neutral of the mains.

Wireless communication between a wall unit 40 and a fluorescent lamp 30 is illustrated in FIG. 3. The wall unit acts as an interface for a user to communicate control signals to the lamp, such as turning the lamp on or off, dim the ballast of a fluorescent lamp, etc. The wall unit comprises a wireless communication circuit 8 including an antenna 9. The antenna may be completely comprised within the wall unit by fabricating the wall unit in a suitable material, such as a material which is transparent to electromagnetic radiation, e.g. plastic.

The wall unit may transmit an electromagnetic signal 12 that can be received by the lamp by use of one of the mains wires 1 as an antenna. The antenna being connected to the lamp driver as described in connection with FIGS. 1 and 2. In FIG. 3 a signal is transmitted from the wall unit to the lamp, the reverse may also be possible, i.e. to transmit a signal from the lamp to the wall unit.

The wall unit may be electrically powered by means of a battery, it may be connected to a mains network, etc. Alternatively, the wall unit may be powered mechanically, such as by energy gained from pressing a button of the unit.

The user control is in the present figure illustrated by a wall unit. The user control may be any type of unit for controlling a lamp. The user control may e.g. be a transceiver box connected to a light control system, e.g. in connection with a light control system of a building.

In the foregoing, it will be appreciated that reference to the singular is also intended to encompass the plural and vice versa, and references to a specific numbers of features or devices are not to be construed as limiting the invention to that specific number of features or devices. Moreover, expressions such as “include”, “comprise”, “has”, “have”, “incorporate”, “contain” and “encompass” are to be construed to be non-exclusive, namely such expressions are to be construed not to exclude other items being present.

Although the present invention has been described in connection with specific embodiments, it is not intended to be limited to the specific form set forth herein. Rather, the scope of the present invention is limited only by the accompanying claims.

Reference signs are included in the claims, however the inclusion of the reference signs is only for clarity reasons and should not be construed as limiting the scope of the claims.

1. A device (10) for wireless control of a lamp (30), the device comprising:
a control interface (4, 6), and
a body for emitting light
wherein the control interface is connected to a mains network (1) comprising at least two mains wires, and wherein at least one of the mains wires is used as a first antenna for wireless control of the lamp.

2. A device according to claim 1, wherein the control interface (4) is connected to the at least one of the mains wires (1) through a capacitive circuit (5).

3. A device according to claim 2, wherein the lamp is a fluorescent lamp (30), and wherein the capacitive circuit (5) is capable of withstanding the ignition voltage necessary to activate the fluorescent lamp.

4. A device according to claim 1, wherein the control interface (6) is coupled to the at least one of the mains wires (1) through an inductive coupling (7).

5. A device according to claim 1, wherein the control interface (4, 6) is capable of receiving and/or transmitting a radio frequency (RF) signal via the first antenna.

6. A device according to claim 1, further including a user control (40) and wherein the user control comprises a second antenna (9) so that signals can be transmitted to the first antenna.

7. A device according to claim 1, further including a user control (40) and wherein the user control comprises a second antenna (9) so that signals can be received from the first antenna.

8. Use of at least one of the mains wires (1) connected to a lamp (30) as an antenna for wireless control of the lamp.

9. A method of transmitting and/or receiving signals between a lamp (30) comprising a first antenna and a user unit comprising a second antenna (9), wherein at least a section of one of the mains wires (1) connected to the lamp is the first antenna.
